(19) United States
(12) Patent Application Publication
(10) Pub. No.: US 2002/0011968 A1
(43) Pub. Date: Jan. 31, 2002

(54) Multi-display apparatus

(75) Inventors: Tadashi Nishio, Iruma-shi (JP); Akihiro Kubota, Tokyo (JP); Fujio Kosaka, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/888,484

(22) Filed: Jun. 25, 2001

(30) Foreign Application Priority Data
Jun. 26, 2000 (JP) 2000-191394

(51) Int. Cl. G09G 5/00

(52) U.S. Cl. 345/5

(57) ABSTRACT

A multi-display apparatus comprises a screen, and a plurality of projectors arranged in at least two columns horizontally and at least two rows vertically. Optical axes of the plurality of projectors corresponding to each column are placed on the same plane and longitudinal angles θ1 and θ2 of the optical paths are made difference as least between two rows. Employing this arrangement enables the plurality of projectors corresponding to respective rows and columns to be positioned as if they form a single light source, prevents the problem of mutual interference between the projection optical paths caused when a given projector enters the projection optical paths of the projectors of each row or column when reflecting mirrors are used, and enables a compact multi-display apparatus to be made.

This application claims benefit of Japanese Application No. 2000-191394 filed in Japan on Jun. 26, 2000, the contents of which are incorporated by this reference.

### BACKGROUND OF THE INVENTION

1. Field of the Invention

The present invention relates to a multi-display apparatus for displaying an integrated large screen image using a plurality of image display apparatuses, and more particularly to a multi-display apparatus for providing a large screen composed of screen images projected by individual image display apparatuses wherein boundary lines (joint portions) between the screen images are not noticeable.

2. Description of the Related Art

Conventionally, projection-type display apparatuses using a cathode ray tube have been served as projection-type image display apparatuses for projecting an enlarged image on a screen, and recently, liquid crystal projection type display apparatus having a liquid crystal panel used as a light valve have been developed.

Further, multi-display apparatuses using a plurality of projection type image display apparatuses in order to provide an integrated large screen image have also been developed.

Such multi-display apparatuses include those for producing an integrated large image by partially overlapping adjacent images from adjacent projection units and then subjecting the image data of the overlapped regions to smoothing as taught in, for example, U.S. Pat. No. 5,956,000 and Japanese Unexamined Patent Application Publication No. 9-326981. This allows a boundary line to be made between adjacent images to be unnoticeable.

Further, the apparatuses include those having a calibration camera placed in front of a screen at the viewpoint position of the audience, thereby photographing an image projected on the screen, and calibrating the image data to be projected based on the picked-up image data, as described in, for example, Japanese Unexamined patent publication No. 9-326981, whereby a plurality of sectional images are projected as if they were a single image.

Still further, the apparatuses include those having a plurality of projectors combined appropriately whose image projection directions are different from the respective optical axes thereof so that the projected sections thereof are positioned in a vertically adjacent relationship as described in, for example, Japanese Unexamined patent publication No. 6-284363 and U.S. Pat. No. 5,902,030. This allows the respective screen images to be seen as if they were projected from a single optical source, and the difference of the directivity of the region near boundary bands between adjacent images is reduced.

The foregoing multi-image display apparatuses using a plurality of projectors in connection with the conventional examples can form a seamless image, however, no reference discloses a technology to reduce the overall size of the apparatus. The reason for this is that when projecting the projection light onto a screen in a linear manner only, the distance from each of the respective projectors to a screen must be same as the projection light path length of the relevant projector, which requires the apparatus to have a considerable depth.

On the other hand, image display apparatuses having a single projector and adapted to deflect the projection light therefrom with the aid of a reflecting mirror have been proposed. However those having a plurality of projectors and adapted to deflect the projection light therefrom with the aid of corresponding reflecting mirrors to produce a larger image have not yet been proposed.

### SUMMARY OF THE INVENTION

Accordingly, it is an object of the present invention to provide a multi-display apparatus, wherein one or more reflecting mirrors are used when a large on-screen image is produced through the use of a plurality of projectors, and thereby the whole apparatus can be reduced in size (particularly in terms of depth).

A multi-display apparatus according to the present invention comprises a screen; a plurality of projectors to project images on the screen; and a common mirror for reflecting projection light fluxes from the plurality of projectors toward the screen.

A multi-display apparatus according to the present invention comprises a screen; and a plurality of projectors to project images on the screen, the plurality of projectors being arranged in at least two columns horizontally and at least two rows vertically, wherein the plurality of projectors corresponding to each column are placed on a single mount.

A multi-display apparatus according to the present invention comprises a frame section having a screen; and a projector mounting section having a plurality of projectors for projecting images on the screen, wherein the apparatus has a structure which can divide into the frame section and the projector mounting section.

A multi-display apparatus according to the present invention comprises a screen; a housing for covering the multi-display apparatus except for the screen; a plurality of projectors to project images on the screen; and an exhaust duct for discharging air heated by a light source to the outside of the apparatus, the exhaust duct extending from the plurality of projectors to the housing.

A multi-display apparatus according to the present invention comprises a screen; a housing for covering the multi-display apparatus except for the screen; a plurality of projectors to project images on the screen; and an air intake duct for taking outside air into the plurality of projectors, the air intake duct extending from the plurality of projectors to the housing.

A multi-display apparatus according to the present invention comprises a screen; a plurality of projectors to project images on the screen, the projectors being arranged in at least three columns horizontally and at least two rows vertically; and a plurality of mirrors positioned in a plurality of optical paths via which the plurality of projectors produce projections, wherein the number of the mirrors positioned in the paths for the projectors disposed on opposing sides is larger than the number of the mirrors positioned in the paths for the projectors disposed centrally.

A multi-display apparatus according to the present invention comprises a screen; a plurality of projectors to project images on the screen; and a plurality of mirrors positioned between the screen and the plurality of projectors for reflecting a projection image, wherein imaginary projector positions, before the mirrors deflect the optical paths, for at least two adjacent projectors are arranged so as to be partially overlapped with each other.

The above and other objects, features and advantages of the invention will become more apparent from the following description when taken in conjunction with the accompanying drawings.

### BRIEF DESCRIPTION OF THE DRAWINGS

FIG. 1 is a cross-sectional side view showing a multi-display apparatus according to a first embodiment of the present invention;

FIG. 2 is a perspective view independently showing the external appearance of a projector with the connection to an exhaust duct near its exhaust port being disasembled;

FIG. 3 is a diagram showing the relative positioning of a plurality of projectors located in the middle and bottom rows when a central projection type multi-display apparatus is constituted through the use of the reflecting mirrors shown in FIG. 1;

FIG. 4 is a diagram, used to explain FIG. 3, showing an impossible arrangement of the plurality of projectors located in a given column when a central projection type multi-display apparatus is constituted without using the reflecting mirrors;

FIG. 5 is a diagram showing a relative positioning of the plurality of projectors located in the top row, taken along the direction A of FIG. 1;

FIG. 6 is a diagram, used to explain the arrangement of the plurality of projectors in the top row of FIG. 5, for illustrating a problem caused when these projectors are arranged in a manner similar to those in FIG. 3;

FIG. 7 is a diagram showing projected images on the screen of the multi-display apparatus;

FIG. 8 is a front view showing the front of the multi-display apparatus according to the present invention;

FIG. 9 shows a cross-sectional side view showing that the apparatus in FIG. 8 consists of two divided sections;

FIG. 10 is a cross sectional side view showing a multi-display apparatus according to a second embodiment of the present invention;

FIG. 11 is a perspective view showing an arrangement of the plurality of projectors in the bottom row and the reflecting mirrors shown in FIG. 10;

FIG. 12 is a cross sectional side view showing a multi-display apparatus according to a third embodiment of the present invention;

FIG. 13 is a cross sectional side view showing a multi-display apparatus according to a fourth embodiment of the present invention;

FIG. 14 is a cross sectional side view showing illustrating a multi-display apparatus according to a fifth embodiment of the present invention;

FIG. 15 is a top view showing the configuration of an air intake duct for the plurality of projectors in a given rack in FIG. 14;

FIG. 16 is a cross sectional side view showing a multi-display apparatus according to a sixth embodiment of the present invention;

FIG. 17 is a partial cross-sectional view showing the structure of a mercury lamp used as a light source lamp;

FIGS. 18A to 18C are explanatory diagrams showing other examples of imaginary positions of the plurality of projectors in the arrangement when reflecting mirrors of the plurality of projectors are used;

FIG. 19 is a side view of a multi-display apparatus showing a comparison of the external dimensions between a conventional multi-display apparatus and a multi-display apparatus of the present invention;

FIG. 20 is a diagram showing the relationship between the height and depth of a multi-display apparatus having a short projection distance when a plurality of projectors are arranged together with reflecting mirrors in a cabinet of the apparatus; and

FIG. 21 is a diagram showing the relationship between the height and depth of a multi-display apparatus having a long projection distance when a plurality of projectors are arranged together with reflecting mirrors in a cabinet of the apparatus.

### DESCRIPTION OF THE PREFERRED EMBODIMENTS

Preferred embodiments of the present invention will be described hereinafter referring to the drawings.

In the following description, the arrangement of a plurality of images projected on to a screen of a multi-display apparatus needs to have two rows or more and two columns or more. When using, for example, an arrangement of two rows and two columns, an integrated large image on a screen is constituted from four images arranged in two rows placed vertically, i.e., top and bottom rows, and two columns placed horizontally, i.e. left and right columns, and four projectors are used to accommodate this configuration. On the other hand, when using, for example, an arrangement of three rows and three columns, an integrated large image on a screen is constituted from nine images arranged in three rows placed vertically, i.e., top, middle, and bottom rows, and two columns placed horizontally, i.e. left, center, and right columns, and a total of nine projectors are used to accommodate this configuration.

The following description illustrates the case of an arrangement of three rows and three columns. It should be noted that “projectors of the top, middle, or bottom row” means herein those corresponding to the projected position on the screen in the top, middle, or bottom row respectively, but does not mean those located in the top, middle, or bottom row in the cabinet of the apparatus.

First Embodiment

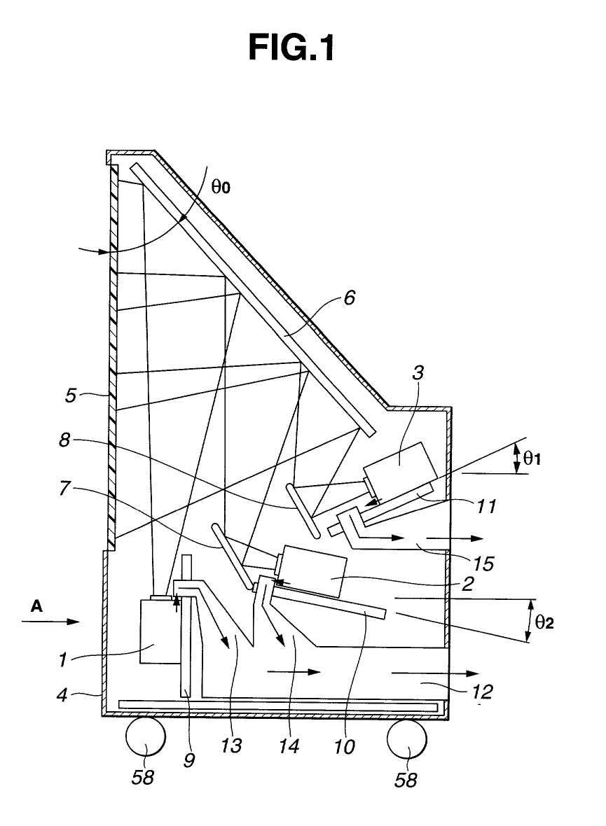

A first embodiment of the invention will now be described referring to FIGS. 1 to 7, 11, 12, 16, 19, 20, and 21.

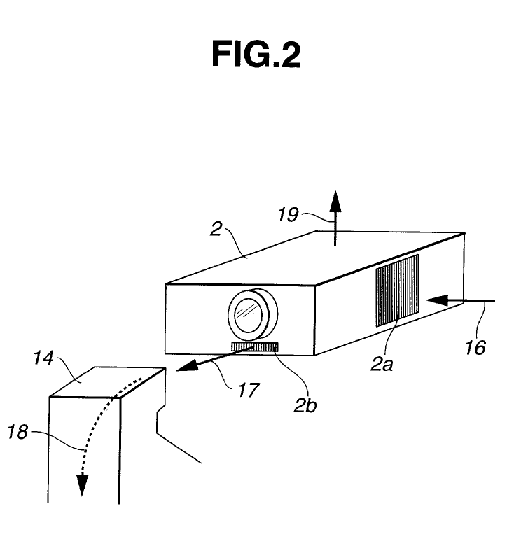

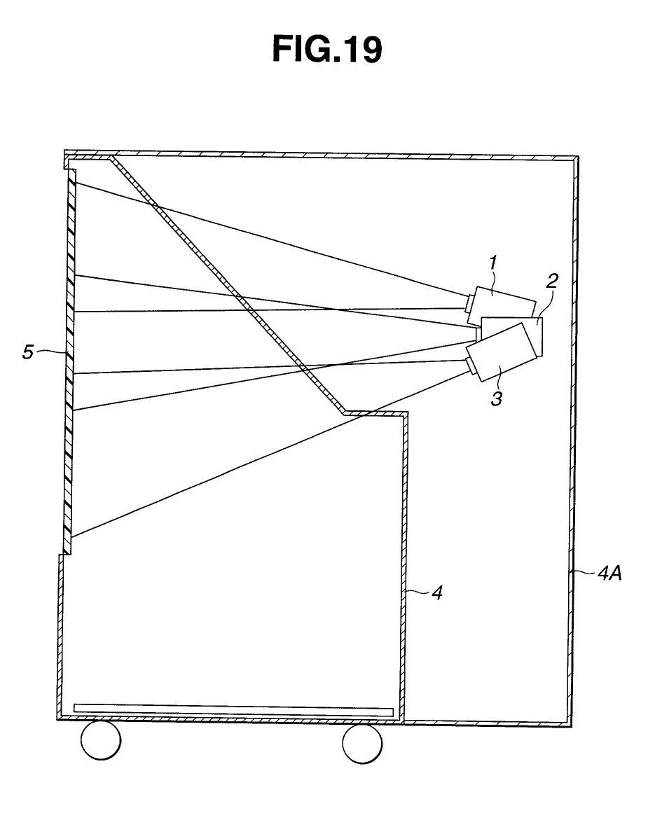

FIG. 1 shows a cross-sectional side view of a multi-display apparatus according to a first embodiment of the present invention. Referring to FIG. 1, a plurality of projectors 1, 2, and 3 are positioned within a cabinet 4 so that it appears as if their projection light fluxes are generated from a single light source. As used herein, the wording “as if their projection light fluxes are generated from a single light source” means “as if imaginary positions of the plurality of projectors 1, 2, and 3 are located at the same position, as shown in FIG. 19”. Projection light fluxes from the respective projectors are deflected by a common reflecting mirror 6 and projected onto a screen 5. (The external appearance of the projector and its periphery are discussed later in connection with FIG. 2.)

In order for it to appear as if the projection light fluxes are generated from one light source, the middle row projector 2 has a light path deflected by a reflecting mirror 7 and the bottom row projector 3 has a light path deflected by a reflecting mirror 8, in the depth direction of the apparatus. The reflecting mirrors 7 and 8 are separate mirrors corresponding to the projectors 2 and 3.

Next, positioning of the projectors when the light paths are deflected by the reflecting mirrors will be described referring to FIGS. 19 to 21.

FIG. 19 provides a comparison of cabinets for multi-display apparatuses: that is, the cabinet 4A having light paths not deflected by the reflecting mirrors and thus not reduced in size, and the cabinet 4 (see FIG. 1) of the present embodiment having light paths deflected by the reflecting mirrors and thus reduced in size. When the light paths are not deflected by the reflecting mirrors, the light paths of the projection light fluxes from the projectors 1, 2, and 3 of the top, middle, and bottom rows extend linearly, and each of the light paths then requires a long distance. This of course also increases the external dimensions, especially the depth, of the cabinet 4A of the apparatus.

When the light paths are deflected by the reflecting mirrors according to the embodiment shown in FIG. 1, angles of the reflecting mirror 7 and 8 for, for example, a 100-inch diagonal screen are determined based on the following conditions:

1) The total height of the multi-display apparatus must not exceed 2.5 m so that the apparatus can be accommodated in an ordinary room; and

2) The respective projectors must maintain the same projection distance in order to make the magnifications of the images on the projection screen equal.

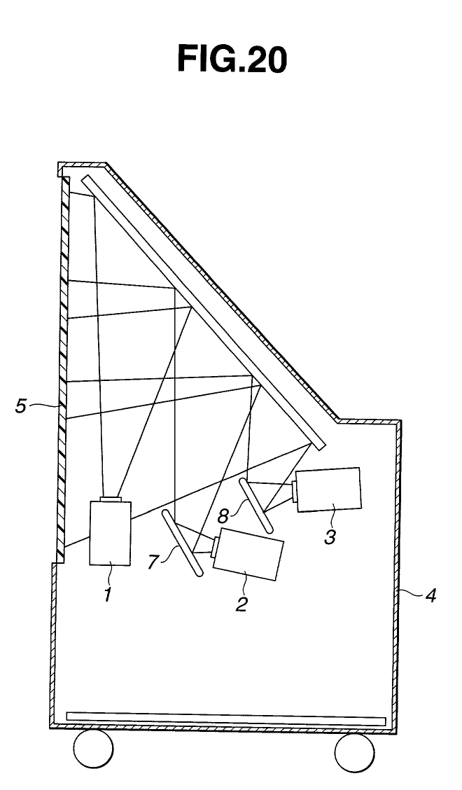

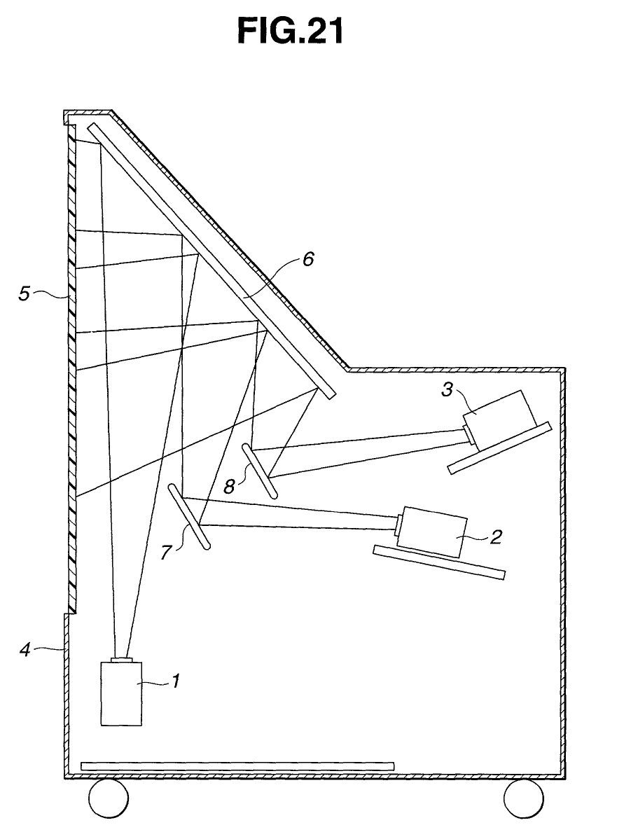

Thus to fulfill these requirements, the configuration must have a projection distance of about 1800 to 2300 mm and the angle θ of the reflecting mirror 6 which is a common mirror for reflecting all the images from the respective projectors in the range of 55 degrees to 60 degrees. With respect to the projection distance, if the imaginary positions of the plurality of projectors 1, 2, and 3 are set at the same position, as shown in FIG. 19, when the projection distance is short, as shown in FIG. 20, the light path length of the top row projector 1 is too short, whereas when the projection distance is too long as shown in FIG. 21, the top row projector 1 is separated from the screen 5, thereby the height of the apparatus 4 increases, and further the light path before deflection of the bottom row projector 3 is lengthened, thereby the depth of the apparatus 4 increases.

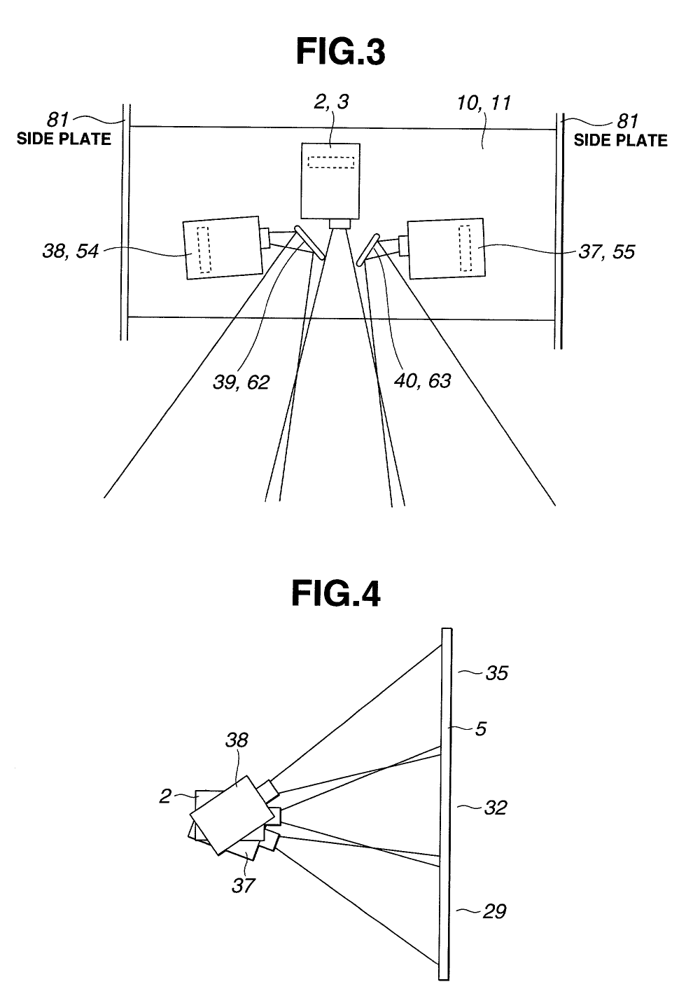

On the other hand, the light paths of the projectors placed horizontally in each of the top, middle, and bottom rows are also deflected by the reflecting mirrors in order to bring the light sources of the imaginary positions closer to form a single light source. This will now be described in detail referring to FIGS. 3 to 7.

First, the description of the state will be made in connection with FIG. 3 and FIG. 4.

In FIG. 4, it can be seen that three projectors 38, 2, and 37 placed on a single mount cannot be positioned as if they form a single light source because doing so causes the outlines of the projectors to overlap one another.

Nevertheless, these projectors can be positioned as if projection is made from the center by deflecting the light paths of the left and right side projectors 38 and 37 disposed at opposite sides of the central projector 2 through the use of reflecting mirrors 39 and 40, respectively.

Further, it is also possible to position the central projector 2 and opposite projectors 38 and 37 on the same plane. As can be seen from the added reference numerals, bottom row projectors 54, 3, and 55 are similar in that the opposite projectors 54 and 55 placed on either side of the central projector 3 are adapted to have their light paths deflected to the center portion by reflecting mirrors 62 and 63, respectively.

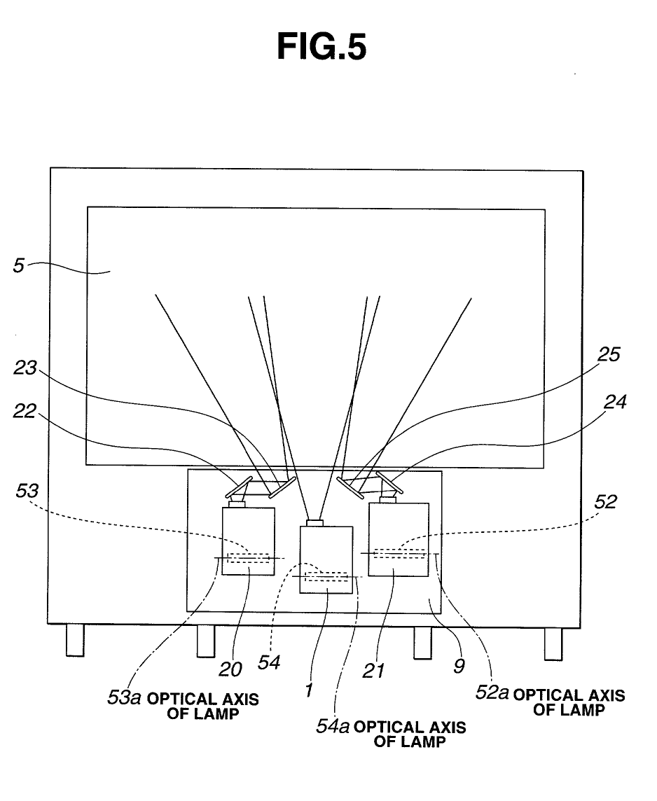

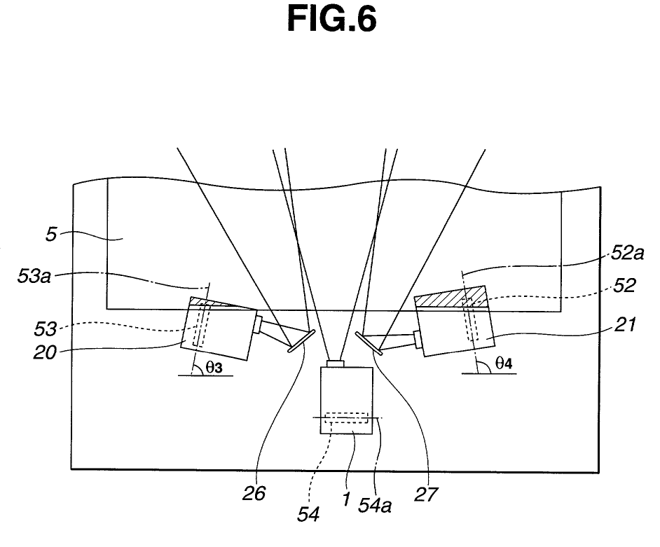

The top row projectors, however, cannot take the arrangement shown in FIG. 3 or FIG. 6, because an attempt to position the top row projectors similarly to FIG. 3 results in positioning the top row projectors as shown in FIG. 6, thereby opposite projectors 20 and 21 cut off the projection light fluxes to the bottom row of the screen 5 (see the hatched area in FIG. 6). Accordingly, for the top row projectors, one more reflecting mirror is added for each of the opposite projectors 20 and 21, and the opposite projectors 20 and 21 are positioned so as to be raised vertically with the aid of the combinations of the reflecting mirrors 22 and 23, and 25 and 24, as shown in FIG. 5.

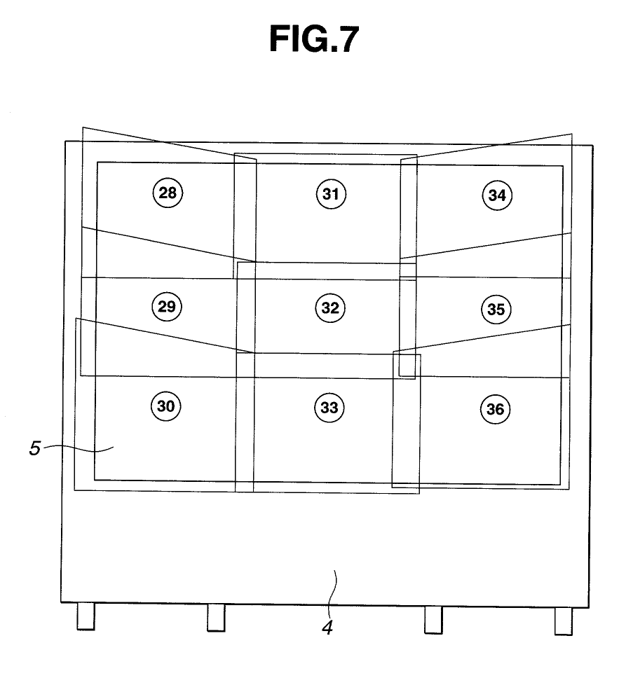

In FIG. 1, mounts 9, 10 and 11 each of which has three projectors mounted thereon are positioned and fixed by left and right side plates (not shown). That is, the relationships between the top, middle, and bottom mounts 9, 10 and 11 are determined on both left and right side plates (e.g. shown in FIG. 3 using symbol 81) which are disposed at both sides of the top, middle, and bottom mounts and installed vertically in such a way that these plates are substantially parallel to the opposite side plates of the cabinet 4, and therefore each of the mounts 9, 10, and 11 can be positioned accurately with respect to each other. In addition, three projectors for each of the top, middle, and bottom rows are positioned on a single horizontal plate (i.e., the mounts 9, 10, and 11, respectively), and therefore can be positioned with high accuracy, which contributes to the prevention of horizontal variations of the projected images. The projected images can be arranged on the screen 5 with good accuracy, as shown in FIG. 7, by combining the procedure of positioning with the left and right side plates, the procedure of positioning the three projectors for each of the top, middle, and bottom rows on a single horizontal plate, and the procedure of three-step high accuracy alignment using the reflecting mirrors, as discussed in connection with FIG. 3 and FIG. 5. Thus, such an approach of horizontally placing the projectors on the same mount, and ensuring the processing accuracy of the mount in the vertical direction by the left and right side plates produces desirable effects for a parallel projection type multi-display apparatus in which a plurality of projectors are arranged for reflection in a matrix-like array with respect to the screen as well as the central projection type multi-display apparatus as described herein in which a single imaginary projection light position is assumed for a plurality of projectors.

As a result of positioning the projectors and the reflecting mirrors as shown in FIG. 5, the upper row projectors 20, 21, and 1 are arranged parallel to each other with the projection ports thereof all facing upward, and therefore optical axes 53a, 52a, and 54a of mercury lamps 53, 52, and 54, as the light source lamps within the respective projectors 20, 21, and 1, can be arranged horizontally with respect to the apparatus installation surface (usually, a horizontal plane), which produces an effect of preventing nonuniform light emission caused by nonuniform distribution of halogen gas and mercury within a mercury lamp as a result of the inclination of the optical axes of the mercury lamps 53, 52, and 54.

In contrast, with the arrangement as shown in FIG. 6, angles θ3 and θ4 with respect to the horizontal plane of the optical axes of the lamps 52 and 53 incorporated in the projector 20 and 21 are increased to cause reduction of the lamp life and nonuniform light emission (nonuniform intensity and nonuniform color), and therefore such an arrangement must not be selected.

The reasons that the arrangement of FIG. 6 is impractical will be detailed below referring to FIG. 17.

In the lamp, a light emission tube 49 incorporating therein electrodes 51 is stuck to a reflecting mirror 27 having a dichroic mirror 50 formed on the inner surface thereof by an adhesive 45. A lead 48 extends from a tip of the light emission tube 49 and is connected to a lead terminal 46 provided on the outside of the reflecting mirror 47. Once the lamp is mounted on the body of the projector and provided with electricity through a base 44 and the lead terminal 46, an electric discharge occurs between the electrodes 51 and halogen gas and mercury within the light emission tube 49 become luminous. The light produced as mentioned above is reflected by the dichroic mirror 50 and serves as projection light. At this time, if this light emission tube 49 is not properly mounted in a horizontal direction but at an angle, nonuniformity in the density distribution of the halogen gas or mercury within the emission tube occurs, which results in nonuniform light emission. In a multi-display apparatus adapted to use a plurality of projectors such as in the present invention, once nonuniform light emission is developed, differences occur in color and brightness between images, and thus nonuniformity occurs in the single integrated image. If light emission is nonuniform, the portion where the light is strongly emitted suffers a problem that an abnormally high temperature occurs, which degrades the components. Since the electrodes reach a temperature of about 600° C. even under normal emission conditions, the influence of the nonuniformity of light emission is large. In order to prevent the nonuniform light emission and reduction of life, it is necessary to maintain the direction of the optical axis of the light emission tube 49 with respect to the horizontal direction to form an angle within ±30°, and preferably within ±20°.

For the projectors 20 and 21, it is not necessary for the optical axes of the lamps 52 and 53 to extend in a horizontal direction, and they may be inclined with respect to the horizontal direction within ±30°, and preferably within ±20°.

This arrangement for the projectors to prevent nonuniform light emission from the lamp and thus reduction of life is similarly applicable to the foregoing middle row projectors 38, 2, and 37 and bottom row projectors 54, 3, and 55. If three projectors for each of the middle and bottom rows are placed in parallel as in the top row (in the case of FIG. 5) and the optical axes of the lamps thereof extend horizontally, each angle of the mounts 10 and 11 can be set as required. This is because the optical axes of the lamps are always kept horizontal irrespective of the angle of the mounts. When three projectors of each row are arranged in parallel, as shown in FIG. 5, however, the number of reflecting mirrors increases by one for each projector compared to the case other than the parallel arrangement as shown in FIG. 3. For this reason, problems of increased light loss at the mirrors and increased complexity of the apparatus arise. Thus, setting the angles θ1 and θ2 of the mounts 10 and 11 within ±30°, and preferably within ±20°, makes the angle of each optical axis of the lamp incorporated in the left and right projectors 38 and 37, and 54 and 55 within ±30° (preferably within ±20°), which allows nonuniform light emission and reduction of life to be prevented. In the case where the lamp can be replaced at an early stage and only the nonuniform light emission needs to be addressed, experiment indicated that no problems occur if the angles θ1 and θ2 of the mounts 10 and 11 are within ±35°.

Next, the periphery of the projector will be described referring to FIG. 1 and FIG. 2.

FIG. 2 shows the structure of a single projector. The respective projectors 1, 2, and 3 have exhaust ports to which exhaust ducts 13, 14, and 15 are connected, respectively. FIG. 2 shows the projector 2, and the exhaust duct 14 located adjacent to the exhaust port of this projector in order to guide hot air from the projector to the outside (exterior) of the apparatus cabinet 4.

When the apparatus is filled with hot air from the projector, the air within the apparatus shimmers and thus the projected image shimmers like a heat haze, which causes displacement of images on the screen especially at an overlapped region of the projected images from each projector and thus degrades the image quality of the projected images. This exhaust duct allows hot air to exit to the outside of the apparatus, and therefore the degradation of the projected imaged due to shimmering of air can be prevented.

The projector 2 has a ventilating fan near its exhaust port 2b for drawing the air 16 within the cabinet 4 through an intake port 2a, cooling the lamp which generates heat or a certain electrical component board, and cooling an LCD (which is an abbreviation of Liquid Crystal Display) element or a DLP (which is an abbreviation of Digital Light Processing) element used for forming the image. The resultant air heated through the air-cooling process becomes hot air having a temperature as high as 70° C. and is exhausted through the exhaust port 2b as exhaust air 17. The ducts 13, 14, and 15 are provided for directly discharging the exhaust air 17 from the respective projectors to the outside (exterior) of the cabinet 4. That is, the hot air within each of the projectors is discharged with the aid of the exhaust fans. In this manner, filling of the hot air within the apparatus (within the cabinet) can be prevented. FIG. 1 shows the ducts 13, 14, and 15 of the central projector 1, 2, and 3, however, the left and right projectors (not shown) are also provided with ducts (not shown) in a similar manner. Further, even if the ducts 13, 14, and 15 do not directly extend to the outside (exterior) of the cabinet 4, it is possible, for example by providing a duct 12, to allow the exhaust air to exit from both of the ducts 13 and 14 together. By the way, symbol 18 represents the exhaust air which is exhausted in the duct 14.

The projected images 28 to 36 from the plurality of projectors arranged as mentioned above are arrayed like a matrix on the screen 5, as shown in FIG. 7. At this time, the left and right images 28-30 and 34-36 exhibit trapezoidal distortion. In addition, the images, including the images 31, 32, and 33 in the center region, are projected with the adjacent images being partially overlapped. Thus, in the state as projected, the resultant integrated image is inconsistent. Then, this projected image is captured by a calibration camera (a camera positioned in front of the screen 5 for photographing the projected image in order to correct deficiencies of the projected image such as distortion of the shape) and the photographed image data is used for correcting the projected image data in order to obtain a visually “seamless” image having a uniform brightness level.

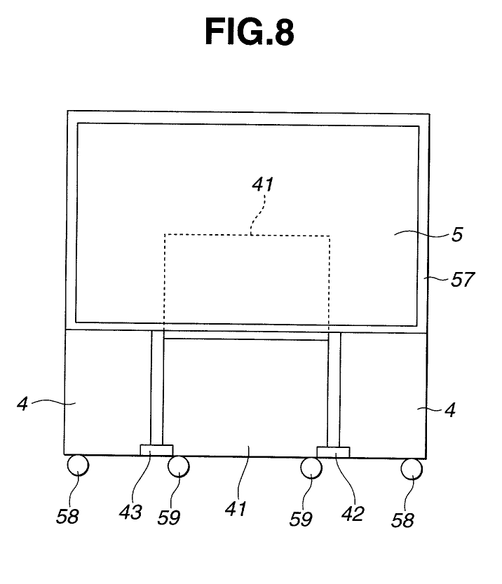

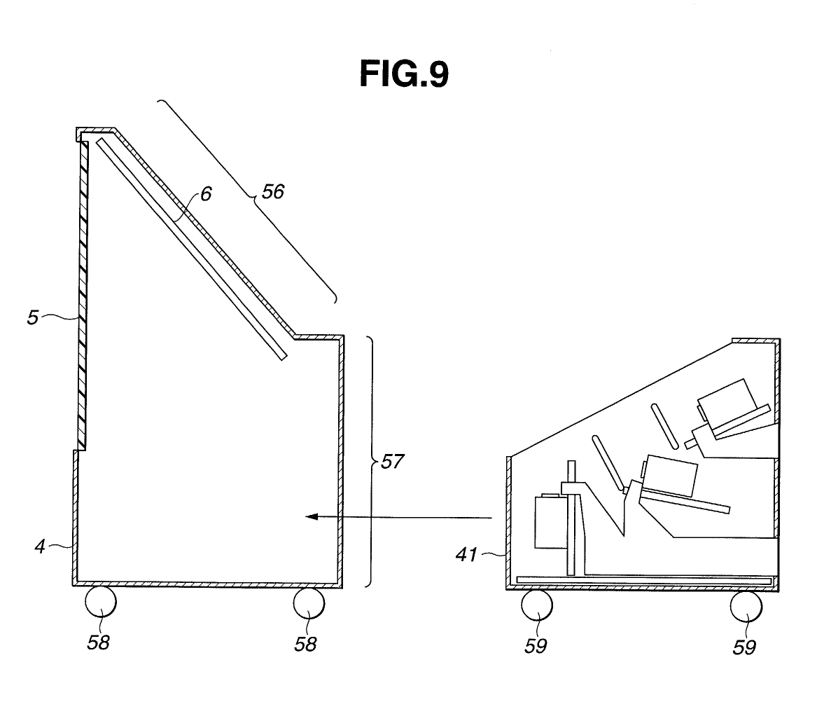

Next, the configuration of the entire apparatus will be described referring to FIG. 8 and FIG. 9. FIG. 8 is a front view for illustrating one example of the configuration of the multi-display apparatus in accordance with the present invention, while FIG. 9 is a cross-sectional side view showing that the apparatus in FIG. 8 consists of two divided sections.

The multi-display apparatus consists of a projector mounting section 41 (hereinafter referred to as an engine section) containing therein a projector, and a cabinet 4 fitted with a screen 5.

As shown in FIG. 9, the cabinet 4 is formed from a screen section 56 incorporating therein a screen 5 and a reflecting mirror 6, and a frame section 57 on which the screen section 56 is placed.

The engine section 41 is adapted to be received by the frame section 57 and is not directly engaged with the screen section 56. Thus the multi-display apparatus is configured so that the engine section 41 and the frame section 57 do not interfere with each other. The engine section 41 and the frame section 57 are joined by joints 43 and 42 for connecting the lower portion of the engine section 41 and the lower portion of the frame part 57.

Although not shown, at the back of the apparatus, the engine section 41 and the frame section 57 are also joined similarly at their lower portions by using joints.

Taking such configuration prevents the optical system for image-forming (including a projector and a mirror), which is mounted within the engine section 41, being adversely affected by distortion of the cabinet 4 or physical shock which are prone to be caused when moving the apparatus. In addition, the weight of the screen section 56 is not applied to the engine section 41 even when the apparatus is installed, so that the apparatus can be easily installed without affecting the optical system for image forming, such as a projector and a mirror, even if the installation floor is not planar.

The frame section 57 is provided with casters 58 while the engine section 41 is provided with casters 59, which allow the apparatus to be moved easily. Such a configuration has the advantage that when some failure occurs inside of the engine section 41, it is easier to make necessary repairs by removing the joints 43 and 42 and withdrawing the engine section 41 from the apparatus cabinet 4 than to make necessary repairs within the apparatus. The joint 43 and 42 is not necessarily required to be separated from the engine section 41. The joints may be integrally formed with the frame section 57 or the engine section 41. After these joints 43 and 42 are connected to the frame section 57 or the engine section 41, a strength sufficient to allow the apparatus to be lifted by a forklift without any problems is required. Accordingly, as the joints 43 and 42, structural iron L-angles or the like are suitable.

Second Embodiment

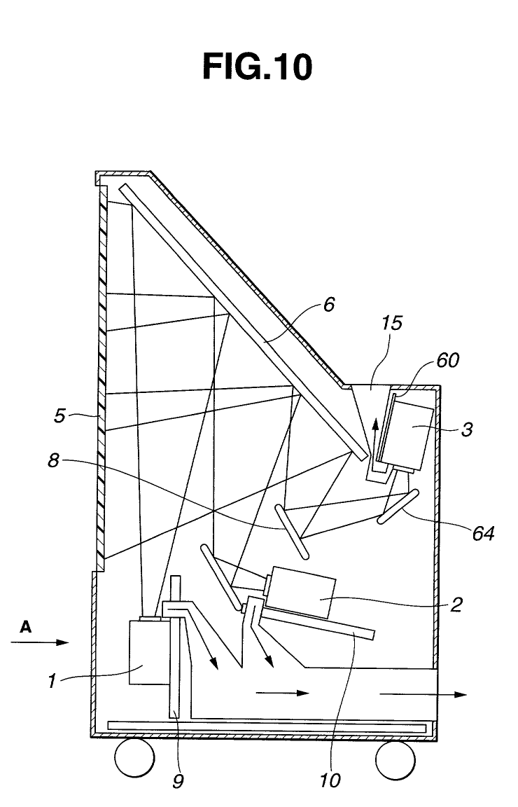

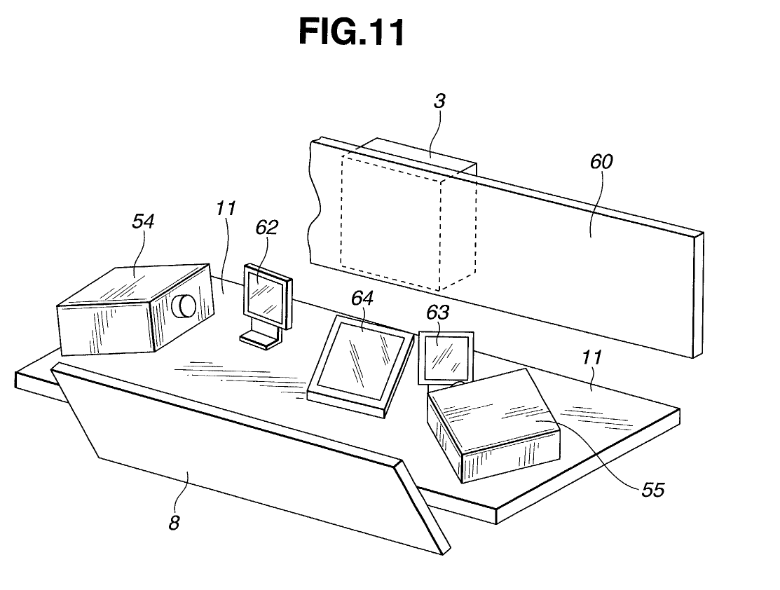

A second embodiment will be described hereinafter referring to FIG. 10 and FIG. 11.

Referring to FIG. 10, a reflecting mirror 64 is provided for the bottom row projector 3 of the first embodiment in order to deflect the projection light therefrom.

As is shown in FIG. 3 and FIG. 1, the central projector 3 among the bottom row projectors 54, 3, and 55 protrudes in a rearward direction of the apparatus, which increases the depth of the apparatus. Such a large size projector is often placed at public squares including an exhibition hall and a lobby, a sales area for advertising commodity products, etc., and its footprint reduces the area for exhibiting other displays or commodity products. Thus, a smaller footprint is welcomed. For this reason, the reflecting mirror 64 is placed on the bottom row mount 11, and the projector 3 is turned upward (with the rear end of the projector 3 shown in FIG. 1 being more raised upwardly with the projection port thereof facing downward). As the image is reversed by the reflecting mirror 64, the projector 3 is supported by a mount 60 which is newly provided in order to support the projector 3 in the reverse direction. The mount 60 may be adapted to be supported by the side plates of the engine section 41 (see FIG. 9) as is the other mounts 9, 10, and 11 as shown in the foregoing, or may be stacked on the mount 11. These mounting approaches allow for decreasing the projection area into a floor direction of the projector 3 and reducing the depth of the whole apparatus compared with the first embodiment. At this time, the exhaust duct 15 of the projector 3 is arranged so as to discharge the exhaust air to the upper side of the apparatus but not to the rear side of the apparatus, in order to achieve commonality of the duct components, for example, with the mount 60. Such an arrangement produces another effect of increasing easiness of discharging the heated air, in addition to the advantage of the commonality of components.

Third Embodiment

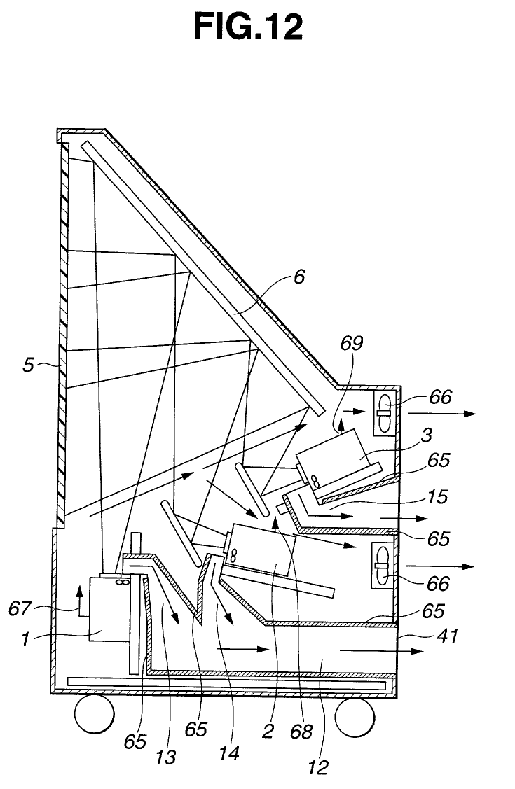

A third embodiment will be described hereinafter referring to FIG. 12.

As is mentioned in connection with FIG. 1 and FIG. 2, in the first embodiment, the resultant hot exhaust air is adapted to discharge to the outside of the apparatus via the exhaust ports of the respective projectors and through the ducts. In order to boost the intensity of a screen, it is necessary to use the light source lamp in the projector having a larger capacity such as 150 W and 200 W than typically used (about 100 W).

This involves an increase of calorific value, and thereby a rise of the temperature and heat quantity of the exhaust air is caused. In such a case, the duct 13, 14, 15, and 12 through which the exhaust air passes are heated and the heat is dissipated inside of the apparatus, which will result in the problem of increasing the temperature around the respective projectors. Under such circumstances, the projectors cannot be air-cooled, which causes nonuniform images or some failures.

Each projector is air-cooled, however, the lamp, electric component board, and LCD or DLP element are located near the projector. Thus, there is another problem that the around the projector is heated, and thereby the heat is dissipated again into the apparatus.

According to one embodiment of the present invention, a thermally insulating material is provided around the ducts 13, 14, 15, and 12 to prevent the heat-dissipation of the duct members heated by the exhaust air. Further, a fan 66 for discharging the air inside of the apparatus to the atmosphere is placed at the back of the engine section 41 (see FIG. 9) having the projectors located therein.

Now, operations of the fan will be described. While the air 67 heated by the heat radiation from the top row projector 1 rises within the apparatus, the air is guided by the fan 66 to the region neighboring thereto and then discharged to the outside of the apparatus. The air 68 heated by the heat radiation of the middle row projector 2 and the hear 69 heated by the heat radiation of the bottom row projector 3 are also discharged similarly to the outside of apparatus through the fan 66. This results the inflow of fresh outside-air to the region around the projectors via different clearances of the apparatus, which enables to always keep the ambient temperature at a temperature close to room temperature. Of course, contamination inside of the apparatus may be prevented by sealing the apparatus, limiting a port for taking therein the outside air, and providing there a dust collection filter for removing dust. While FIG. 12 illustrates an example where air is discharged from the back of the multi-display apparatus, however, such air may be discharged through a fan provided at a front or side of the apparatus.

Fourth Embodiment

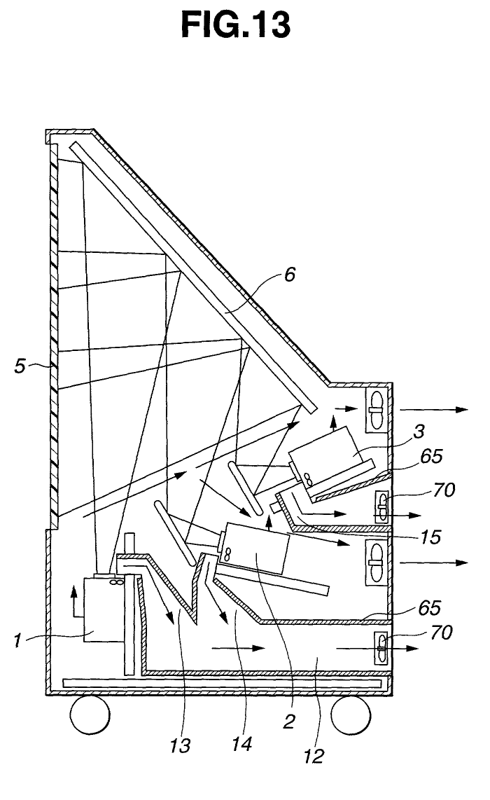

A fourth embodiment will be described hereinafter referring to FIG. 13.

In the first, second, and third embodiments, such a duct for letting out the exhaust air of the projectors to outside of the apparatus extend to the rear side of the apparatus by bypassing structural elements such as projectors and mirrors located within the apparatus, to the outside of the apparatus. Thus, it is difficult to have a duct extending linearly, and which tends to increase the flow resistance. Accordingly, a fan 70 is provided at a rear end of the exhaust duct so as to face outside of the multi-display apparatus for forced exhaust. By configuring as mentioned above, exhaust is performed smoothly even if the duct shape is complex, and the air-cooling effect of the projector can be maintained.

Fifth Embodiment

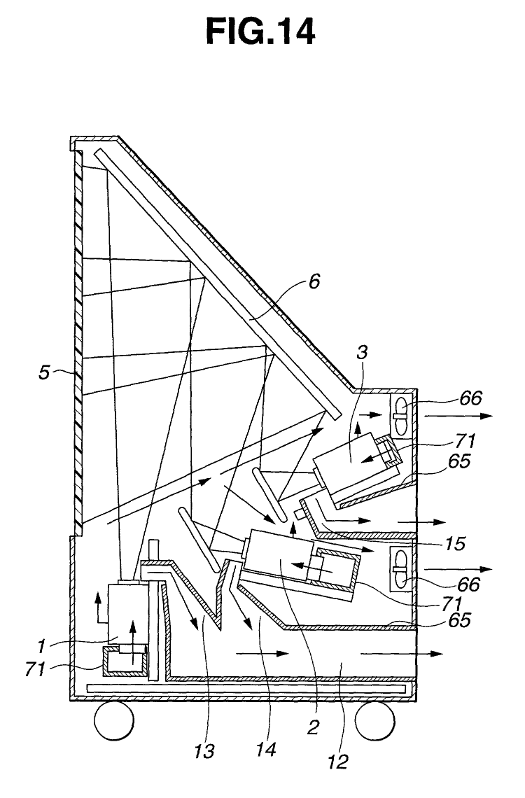

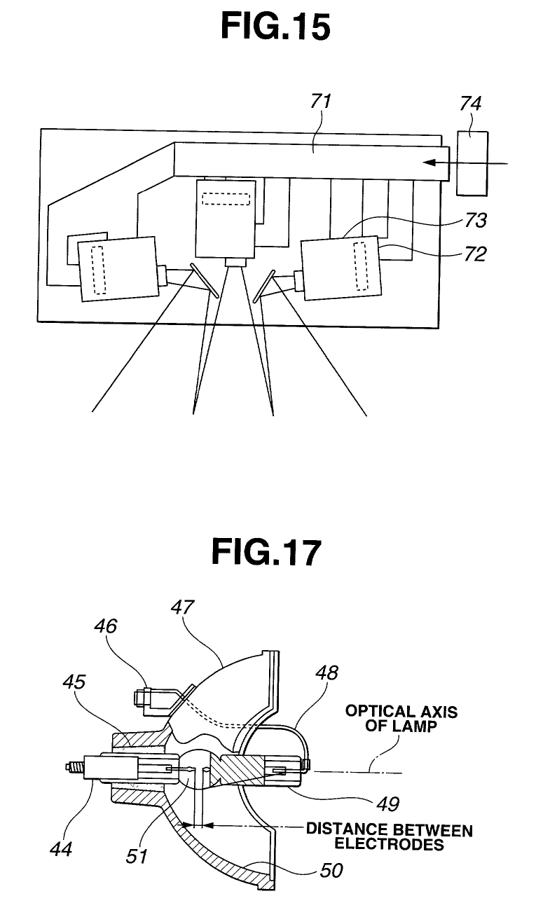

A fifth embodiment will be described hereinafter referring to FIG. 14 and FIG. 15.

In the first and second embodiments, air taken by each of the respective projectors is that around the projector. However, such air has already been heated due to the heat radiation from the duct thereof or from other projectors. Even if it is configured to exhaust such air to the outside of the apparatus through the use of the fan 66 as illustrated in connection with the third and fourth embodiments, the heated air gathered from various portions within the apparatus is concentrated to the projectors near the fan 66 and the temperature there becomes slightly higher than the room temperature.

Therefore, an air intake duct 71 is provided as shown in FIG. 14 in order to supply every projector with outside air, that is, the air at a room temperature. Then, the air intake duct 71 is provided with an intake from the outside on the side of the apparatus, and connected to the intake port of each projector.

When the intake portions of the projector are located at a two portions (designated by reference numerals 73 and 72), the intake duct is connected appropriately to each of the two intake portions. Ducts that are directly communicated with the outside of the apparatus may be provided for each of the projectors, however, in the case of the configuration where projectors are concentrated as in the present embodiment, a plurality of ducts may be integrated to a single common duct 71 as shown in FIG. 15 from which piping is branched to the respective projectors. When air is taken from the lower part of the apparatus, the duct 71 may be adapted to integrate those in a single vertical column.

Further, when the inside temperature of the apparatus is high, the intake duct 71 is required to be surrounded by a heat insulating material so that it is not heated inside of the apparatus.

Still further, a dust collection filter 74 for removing dust may be provided at an inlet port of the intake duct 71 in order to prevent dust from flowing into the projectors. By taking such a configuring for the duct collection duct 71 as mentioned above, an operator is allowed to make exchange of the duct collection filter 74 or maintenance from outside of the apparatus, which provides a structure having good maintainability. A dust collection filter (not shown) is also usually disposed near the intake ports 73 and 72 within the projector.

The configuration in accordance with the fifth embodiment mentioned above enables the outside air at an air temperature to be led to the projectors.

Sixth Embodiment

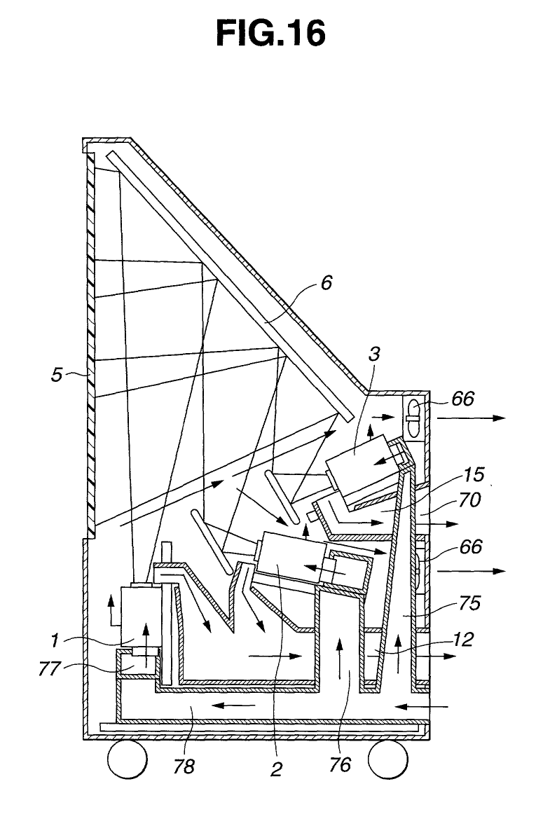

A sixth embodiment will be described hereinafter referring to FIG. 16.

The fifth embodiment discussed in connection with FIG. 14 and FIG. 15 proposed a configuration of an intake duct 71 which takes in air from the side of the apparatus.

In the sixth embodiment shown in FIG. 16 illustrates the case when the intake duct 78 is provided on the same plane as of the exhaust ducts 15 and 12. Here, the intake duct 78 has an air intake from outside which is disposed at a position lower than the exhaust ducts 15 and 12. The air intake is also disposed at a lower position than the fan 66 for discharging the inside air. In the present embodiment, the intake duct 78 is provided as a common duct for integrating the respective intake ducts 77, 76, and 75 together, while the respective intake ducts 77, 76, and 75 extend upward so as to be connected with the respective projectors in the apparatus.

In addition, the respective intake ducts connected to the respective projectors may be directly connected to the respective air intakes from the outside without providing a common intake duct 78, or the respective projectors may be connected to the intake duct 71 common to the projectors in the same row as discussed in connection with the fifth embodiment shown in FIG. 15.

By taking such an arrangement as mentioned above, the air at a temperature higher than the room temperature from the exhaust ducts 15 and 12 and the exhaust fan 66 is discharged to the outside at a position higher than that of the intake duct 78 and then moves upward. Thus the intake duct 78 which is located at a position lower than the exhaust ducts 15 and 12 and the exhaust fan 66 is allowed to take in the outside air at a room temperature.

Further, when the inside temperature of the apparatus is high, the intake ducts 78, 77, 76, and 75 are required to be surrounded by a heat insulating material so that they are not heated inside of the apparatus.

Still further, a dust collection filter 74 for removing dust may be provided at an air intake of the intake duct 78 from the outside in order to prevent dust from flowing into the projectors. By taking such an arrangement as mentioned above, an operator is allowed to replace the duct collection filter or perform maintenance from outside of the apparatus, which provides a structure having good maintainability.

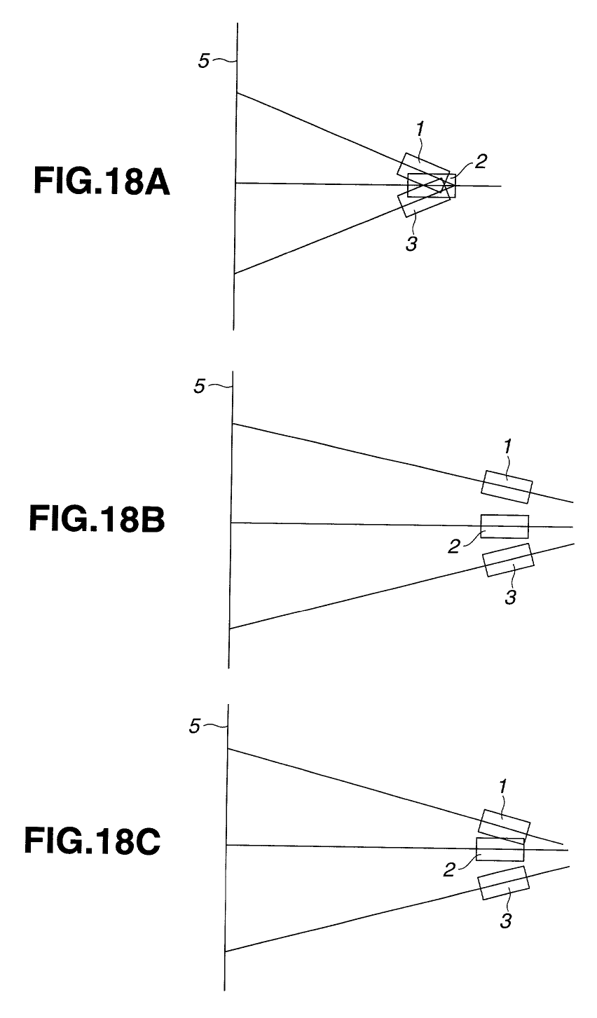

In the embodiments described above, a plurality of projectors has projection optical paths which are deflected by the reflecting mirrors. Ideally, the imaginary projector positions are placed at a single position (see FIG. 18A), as shown in FIG. 19 and FIG. 4 (in either case, a reflecting mirror is not used). However, as is shown in FIG. 18B and FIG. 18C, the plurality of imaginary projectors need not overlap completely but need only be gathered closer to the inner side of the other (center) with respect to the projection direction of the other. Herein, the imaginary projector position means the projector position where the projection light fluxes of the respective projectors form visual images on the screen 5 when the projection optical path of a plurality of projectors extend linearly without being deflected. If the projectors are disposed closer to inside, an effect of orientating the direction of each of the projector projection light to a desired direction becomes equivalent to the foregoing identical case (see FIG. 18A). Further, the imaginary projector positions may be arranged so that at least two adjacent projectors are partially overlapped with each other, as shown in FIG. 18C.

While the above embodiments have been described using an arrangement of three rows and three columns of projection images to the screen by way of example, the present invention is not limited thereto, and an arrangement of two rows and two columns of projection images may be used, which of course can be reduced in size by using reflecting mirrors.

As is mentioned above, in accordance with the present invention, when a multi-display apparatus with a large onscreen image is constituted using a plurality of projectors, the whole apparatus can be reduced in size (particularly in terms of depth) through the use of reflecting mirrors. Further, the cooling effect within the apparatus can be increased by providing exhaust and intake ducts.

Having described the preferred embodiments of the invention referring to the accompanying drawings, it is to be understood that the invention is not limited to those precise embodiments and that various changes and modifications thereof could be effected by one skilled in the art without departing from the spirit or scope of the invention as defined in the appended claims.

What is claimed is:

1. A multi-display apparatus comprising:
a screen;
a plurality of projectors to project images on the screen; and
a common mirror for reflecting projection light fluxes from the plurality of projectors toward the screen.

2. A multi-display apparatus according to claim 1,
further comprising individual mirrors corresponding to the plurality of projectors respectively are provided between the common mirror and the plurality of projectors.

3. A multi-display apparatus according to claim 1,
wherein each of the plurality of projectors comprises a mercury lamp as a light source, and the mercury lamp is disposed so that the angle between the optical axis of the mercury lamp and the horizontal is 30 degrees or less.

4. A multi-display apparatus comprising:
a screen; and
a plurality of projectors to project images on the screen, the plurality of projectors being arranged in at least two columns horizontally and at least two rows vertically, wherein the plurality of projectors corresponding to each column are placed on a single mount.

5. A multi-display apparatus comprising:
a frame section having a screen; and
a projector mounting section having a plurality of projectors for projecting images on the screen, wherein
the apparatus has a structure which can divide into the frame section and the projector mounting section.

6. A multi-display apparatus comprising:
a screen;
a housing for covering the multi-display apparatus except for the screen;
a plurality of projectors to project images on the screen; and
an exhaust duct for discharging air heated by a light source to the outside of the apparatus, the exhaust duct extending from the plurality of projectors to the housing.

7. A multi-display apparatus according to claim 6, wherein the exhaust duct is covered with a heat insulating material.

8. A multi-display apparatus according to claim 6, wherein the duct is provided with an exhaust fan.

9. A multi-display apparatus according to claim 8, wherein the exhaust fan is positioned so as to face outside of the multi-display apparatus.

10. A multi-display apparatus according to claim 8,
wherein the exhaust fan is positioned within each of the projectors.

11. A multi-display apparatus comprising,
a screen;
a housing for covering the multi-display apparatus except for the screen;
a plurality of projectors to project images on the screen; and
an air intake duct for taking outside air into the plurality of projectors, the air intake duct extending from the plurality of projectors to the housing.

12. A multi-display apparatus comprising,
a screen;
a plurality of projectors to project images on the screen, the projectors being arranged in at least three columns horizontally and at least two rows vertically; and
a plurality of mirrors positioned in a plurality of optical paths via which the plurality of projectors produce projections, wherein the number of the mirrors positioned in the paths for the projectors disposed on opposing sides is larger than the number of the mirrors positioned in the paths for the projectors disposed centrally.

13. A multi-display apparatus comprising,
a screen;
a plurality of projectors to project images on the screen; and
a plurality of mirrors positioned between the screen and the plurality of projectors for reflecting a projection image, wherein imaginary projector positions, before the mirrors deflect the optical paths, for at least two adjacent projectors are arranged so as to be partially overlapped with each other.
